(19) United States
(12) Patent Application Publication
(10) Pub. No.: US 2013/0288701 A1
(43) Pub. Date: Oct. 31, 2013

(54) USER INTERFACE, ASSOCIATED APPARATUS AND METHODS

(71) Applicant: Nick Foster, San Francisco, CA (US)

(72) Inventor: Nick Foster, San Francisco, CA (US)

(73) Assignee: NOKIA CORPORATION, Espoo (FI)

(21) Appl. No.: 13/455,622

(22) Filed: Apr. 25, 2012

(51) Int. Cl. H04W 4/02

(52) U.S. Cl. 455/456.1

(57) ABSTRACT

An apparatus comprising at least one processor; and at least one memory including computer program code, the at least one memory and the computer program code configured to, with the at least one processor, cause the apparatus to perform at least the following: enable determination of a location match between a location of an electronic device and a location of a contact, the contact associated with a contact entry for the electronic device, and enable the contact entry to be prioritised based on the location match.

### TECHNICAL FIELD

The present disclosure relates to the field of user interfaces (including user interfaces related to contact lists), associated methods, computer programs and apparatus. Certain disclosed aspects relate to portable electronic devices, in particular, so-called hand-portable electronic devices which may be hand-held in use (although they may be placed in a cradle in use). Such hand-portable electronic devices include so-called Personal Digital Assistants (PDAs) and tablet personal computers.

The portable electronic devices/apparatus according to one or more disclosed aspects may provide one or more audio/text/video communication functions (e.g., tele-communication, video-communication, and/or text transmission (Short Message Service (SMS)/Multimedia Message Service (MMS)/e-mailing) functions), interactive/non-interactive viewing functions (e.g., web-browsing, navigation, TV/program viewing functions), music recording/playing functions (e.g., MP3 or other format and/or (FM/AM) radio broadcast recording/playing), downloading/sending of data functions, image capture function (e.g., using a (e.g., in-built) digital camera), and gaming functions.

### BACKGROUND

Many modern electronic devices allow lists of contacts to be stored, accessed and edited. For example, a desktop computer may allow a user to use an electronic address book application. A contact person may have an entry in the electronic address book, and the entry may include information such as they contact's name, telephone numbers, e-mail addresses and physical postal addresses. Other examples of contact lists include a contact list of a mobile telephone or smartphone, which a user of the device may use to store contact telephone numbers and other contact information.

Information in the contact lists may be edited by a user. For example, if a contact person moves house, the user may wish to update the stored contact information for that contact to include the contact's new address. Contact information and other details of the user of the electronic device may also change.

The listing or discussion of a prior-published document or any background in this specification should not necessarily be taken as an acknowledgement that the document or background is part of the state of the art or is common general knowledge.

### SUMMARY

In a first aspect, there is provided an apparatus, the apparatus comprising:
at least one processor; and
at least one memory including computer program code,
the at least one memory and the computer program code configured to, with the at least one processor, cause the apparatus to perform at least the following:
enable determination of a location match between a location of an electronic device and a location of a contact, the contact associated with a contact entry for the electronic device, and
enable the contact entry to be prioritised based on the location match.

A location of an electronic device, and of a contact, may be considered as a geographic location such as a country, city, town, village, street/road, postcode/zip code, or building. Such a location may be determined by global positioning system functionality of the electronic device/contact's electronic device, for example. A user of the electronic device, and/or a contact, may specify his or her location in an e-mail, SMS message, MMS message, chat message, social media post or (micro)blog post. For example, a contact or a user of an electronic device may post a social media message for his/her social media contacts to see, stating “Having a great time visiting Copenhagen”. Accordingly the user's/contact's location can thus be considered to be Copenhagen.

The location of a contact may be specified in a calendar entry. For example, a user may create a new event in a calendar which includes one or more contact names and a location, such as “Progress meeting with Jeff, Dan and Margaret, 12:30, 15 Apr. 2014, Boardroom, Plasco Plastics, Dublin.” The contact names are Jeff, Dan and Margaret (and each listed contact name may be linked to a contact entry for the electronic device of the user, including further details of each contact person such as their full name and contact details). The location given is “Boardroom, Plasco Plastics, Dublin”.

Respective entries for contacts may be, for example, categorised as a family member, business colleague, friend, business or service provider (e.g., a dentist or mechanic). A contact entry may be considered as an address book-type entry containing details of a particular contact. One or more contact entries associated with contacts may be available in a list such as an electronic address book, a social media contact list, a microblog contact/followers list, or an e-mail address book list.

A location match may occur, for example, if the electronic device has a location specified as “Manchester”, and if a contact is listed in an address book as a home location of “Manchester”. A location match may also occur if, for example, the electronic device has a location specified as “Edinburgh”, and if a contact is listed in an address book as a home location of “Physics Dept., Edinburgh University”. Although these two locations are not identical, the Physics department of Edinburgh University is in the city of Edinburgh, thus the locations may be considered to be matched.

The location of the electronic device used in the location match may be one or more of the current location of the electronic device or a future location of the electronic device. The future location of the electronic device may be determined from a calendar event associated with the electronic device.

As an example, the apparatus/electronic device may allow use of a calendar application. A calendar entry/event may state that the user of the apparatus/electronic device has a meeting at the location of “Buildwell Offices, Bradford”. One or more contact entries may also be listed in the calendar entry as attending the same meeting, thus for the period of time of the listed meeting (whether at the present time or at a time in the future), the contact entries listed in the calendar entry also have a location of “Buildwell Offices, Bradford”, thus proving one or more location matches. A user may wish to know which of his contacts will be in the same location as him during (and possibly for a period of time before) a meeting, in order to organise who may be able to attend. The user may also wish to have a record of location matched colleagues in order to be able to contact them easily. For example, if the contact details of his location matched colleagues are all available on one screen, rather than listed in a general contact list with many other non-location matched contacts, then the user may find it easier to contact those location matched colleagues.

The location of the contact used in the location match may be one or more of the current location of the contact or a future location of the contact. The respective current and future locations of the contact may be determined from location data provided by an apparatus associated with the contact of the contact entry.

For example, a contact may have an associated contact entry in a social media application, and that contact may have posted a social media message stating that they are currently in London (i.e. their location is London). The contact has provided his or her location by posting the location “London” in a social media message. A user of the apparatus/electronic device may also be in London. Upon the apparatus/electronic device detecting the contact's social media message and determining that the contact is in London, there may be a location match between the user (and the user's apparatus/electronic device) in London and the contact who posted a social media message stating that their location was London. This may be desirable for a user, who may wish to know which of his friends are in the same location as the location he has just travelled to, so that he can arrange to meet up with them. The location information for the contact may be provided by a device/apparatus of the contact used to determine the location of the contact e.g., by GPS information provided by a contact's device/apparatus.

The electronic device may be a portable electronic device such that its location can vary. The location of the contact may be fixed. The apparatus may be configured to enable the determination of the location match between the varying location of the portable electronic device and the fixed location of the contact.

For example, a contact may be listed, in a contact entry, as being located in Paris (such as, for example, a business contact based at an office in Paris). A user may use a portable electronic device such as a mobile telephone, smartphone, tablet computer or PDA. The portable electronic device may have GPS location determination functionality and therefore the current location, which may vary, of the portable electronic device may be available to the portable electronic device at any time during operation of the GPS functionality. If the user (and the user's portable electronic device) travel to Paris, the apparatus may determine a location match between the (user and the) portable electronic device, and the contact who has a contact entry listing Paris as a location.

The electronic device may be a non-portable electronic device, such that its location is fixed. The location of the contact may be such that the location of the contact can vary. The apparatus may be configured to enable the determination of the location match between the fixed location of the non-portable electronic device and the varying location of the contact.

For example, a contact may post on a social media website that they are visiting Helsinki on holiday. A user using a non-portable electronic device such as a desktop computer may be based in Helsinki. A location match may be determined between the non-portable electronic device and the contact who currently has a contact entry listing Helsinki as his or her location due to their social media post stating that he or she is in Helsinki.

The electronic device may be a portable electronic device such that its location can vary. The location of the contact may be such that the location of the contact can vary. The apparatus may be configured to enable the determination of the location match between the varying location of the portable electronic device and the varying location of the contact. For example, both the electronic device, and a device of a contact, may be portable (such as each device being a mobile telephone, smartphone, PDA, tablet computer, or other portable electronic device). As another example, a user may have a portable electronic device such as a mobile telephone, and a contact listed in a contact entry of the portable electronic device may be travelling, and may regularly update their current location by posting messages on a social media website, or by sending e-mails and/or chat messages to a user of the electronic device from internet cafés.

The apparatus may be configured to enable the contact entry to be prioritised by pinning the contact entry, or by pinning a shortcut associated with the contact entry, to a home screen of the electronic device according to the location match. For example, if a contact entry is determined to be a contact entry for prioritisation, due to a location match between the location of the electronic device and the location of the contact associated with the contact entry, the contact entry (or a shortcut or representation of the contact entry) may be displayed on a home screen of the electronic device. It may be envisaged in other examples that the prioritisation of a contact entry may be achieved by a sound alert associated with the contact entry and indicating that the contact entry is location-matched.

In this way, a user of the electronic device may find it easy and convenient to determine who, of his or her contacts, is in the same location/region/area by simply looking at the home screen of his or her electronic device (particularly if that contact entry/shortcut was not previously on the home screen), or hearing a sound alert indicating a location-matched contact entry. The user need not perform any inputs, or menu navigation, for example, to see which contacts are in the same location. Contacts in the same location may be displayed on the home screen, if their location matches that of the user's electronic device, allowing the user to quickly and easily see “local” contacts in the same location as him/herself.

The apparatus may be configured to enable the contact entry to be prioritised by pinning the contact entry, or by pinning a shortcut associated with the contact entry, to a home screen of the electronic device according to the location match for the duration of the location match. For example, if a contact is determined to be in the same location as the user's electronic device for a period of one week (for example, while the user is abroad on a business trip), then the contact entry may be displayed on the home screen of the user's electronic device only for the duration of the user's business trip, and may not appear on the home screen before and after the user's business trip. In this way timely information on who is currently in the same location as the user (and their electronic device) is readily available for the user. When there is no longer a location match (for example, if the contact moves to a location away from the user's electronic device), the corresponding contact entry (or associated shortcut) is no longer prioritised, and therefore is no longer pinned to a home screen of the user's electronic device.

As another example, a user of an apparatus/electronic device who is usually based in the UK may have a calendar entry stating that the user has a business meeting in New York for three days. During those three days when the user is in New York, any contacts who have contact entries showing that the associated contacts are also in New York may be location matched, and may be displayed on a home screen of the user's electronic device. When the user is not in New York (that is, before and after the scheduled meeting in the calendar), the contact entries showing that the associated contacts are in New York may not be location matched, as they are not in the same location as the user (who may be in the UK). Thus, contact entries which are not location matched with the location of the user's electronic device (for example, contacts who are permanently located in New York) may not be pinned or displayed to a home screen of the user's electronic device.

In another example, a user may be travelling to Florida from Germany on a business trip. Any business contacts of the user who have a location matching “Florida” may be location matched for the duration of the scheduled business trip and each location matched contact may have a contact entry (or shortcut to a contact entry) pinned to a home screen of the user's portable electronic device. These same location matched contacts may also be location matched, and thus may each have a contact entry (or shortcut to a contact entry) pinned to the home screen of the user's portable electronic device, for a predetermined period of time before the foreign business trip (for example for one week before the scheduled trip). This may be advantageous for the user, who may wish to contact the colleagues he will be working with during the business trip just prior (in the week before) the trip, for example to arrange local travel plans in Florida and to agree meeting agendas. Having these Florida-based contacts' contact entries (or shortcuts to contact entries) pinned to the user's device home screen may allow the user to quickly and easily contact relevant business contacts.

The apparatus may be configured to enable the contact entry to be prioritised by reordering a list of contact entries associated with respective contacts in a hierarchical order. The contact entry associated with the location match may be placed higher in the hierarchical list of contact entries. Thus, a location matched contact entry may appear prioritised at the top of an otherwise alphabetical contact list, for example.

The apparatus may be configured to order multiple contact entries associated with the location match according to location proximity. The multiple contact entries associated with the closest location proximity may be placed with a higher priority in the hierarchical list of contact entries. Therefore several contacts who have a location matching that of the user may be listed at the top of a contact list, or displayed pinned on the home screen of a user's portable electronic device, for example. A location proximity distance (of, for example, 20 kilometres) may be preset in the user's portable electronic device. A location matched contact within 15 km of the user's location may be location matched, but may appear with a lower priority in a hierarchical list of location matched contact entries (for example, lower in a list) than another location matched contact within the closer distance of 2 km of the user's location.

The apparatus may be configured to enable the determination of the location match based on the location of the electronic device and the location of the contact being within a predetermined location proximity.

For example, a location match may be determined if the location of the user's electronic device and the location of a contact are within a same geographic boundary, such as the user's electronic device having a location of Chelsea, London, and the contact having a location of London (both the user's electronic device and the contact are in the same geographical location of London). Another example may be if the user's electronic device has a location of Bloomington, Ill., and the contact has a location of Springfield, Ill. (both locations are in the same US state of Illinois). Another example may be if the user's electronic device and the contact each have locations which are within a predetermined distance of each other; for example within 30 km of each other (of course the predetermined distance may be larger or smaller than 30 km).

The apparatus may be configured to enable the determination of the location match for contact entries having a particular categorisation. For example, only contacts listed as business contacts may be available to be location matched, and even if a contact is in the same location as the user's electronic device, if they are not listed as a business contact (for example, they are listed as a social media contact or a family contact), they may not be location matched with the location of the user's electronic device.

The apparatus may be configured to enable the contact entry to be prioritised for contact entries having a particular categorisation. The contact entry categorisation may provide for grouping of contact entries, and the grouping may include one or more of business contact grouping, family contact grouping, friend contact grouping, holiday contact grouping, and business trip contact grouping.

The apparatus may be configured to receive the location of the contact from one or more of an application associated with the contact or an apparatus associated with the contact. For example, a contact may transmit their location to the user's electronic device by Bluetooth transmission, or over a wireless local area network. The contact may post their location on a social media website which may be detected by the user's electronic device. The contact may e-mail the user their location, which may be detected by the user's electronic device.

The contact entry may be configured to store contact details for the contact, and the contact details may comprise one or more of a contact name, contact photo, contact fixed/landline telephone number, contact mobile telephone number, contact work postal address, contact home postal address, contact work email address, contact home e-mail address, contact social medium address, or a shortcut for one or more of the same.

The apparatus may be configured such that the contact entry is still provided in a contact list associated with multiple contacts, but the contact entry (or an associated shortcut) may also be prioritised (for example, for easy or quick access) e.g., by highlighting, for the duration of the location match.

The apparatus may be configured such that the contact entry (or an associated shortcut) may allow for electronic communication with the contact. The contact entry, or shortcut for the contact entry, may be actuable. For example, the apparatus may be configured to open a pre-addressed e-mail, SMS, MMS or calling application upon a user selecting the prioritised (shortcut for the) contact entry.

The apparatus may be configured such that an associated shortcut for the contact entry displayed on a home screen of an electronic device is not actuable. Therefore, the associated shortcut for the contact entry may not allow for electronic communication with the contact. If the associated shortcut for the contact entry on the home screen is not actuable, then the displayed shortcut on the home screen of the electronic device may act as a reminder/prompt that the associated contact is in location proximity to the electronic device.

The apparatus may be a portable electronic device, a mobile telephone, a smartphone, a tablet computer, a personal digital assistant, a laptop computer, a media player, a non-portable electronic device, a desktop computer, a server, or a module/circuitry for one or more of the same.

The contact entries in a list may be accessible by the apparatus, and may be stored on a memory located with the apparatus, stored on a server remote from, and accessible by, the apparatus, or stored on a computing cloud remote from, and accessible by, the apparatus.

In another aspect, there is provided a method, the method comprising:
enabling determination of a location match between a location of an electronic device and a location of a contact, the contact associated with a contact entry for the electronic device, and
enabling the contact entry to be prioritised based on the location match.

In another aspect, there is provided a method, the method comprising:
determining of a location match between a location of an electronic device and a location of a contact, the contact associated with a contact entry for the electronic device, and
prioritising the contact entry based on the location match.

In another aspect there is provided a computer readable medium comprising computer program code stored thereon, the computer readable medium and computer program code being configured to, when run on at least one processor, perform at least the following:
enable determination of a location match between a location of an electronic device and a location of a contact, the contact associated with a contact entry for the electronic device, and
enable the contact entry to be prioritised based on the location match.

The computer program may be stored on a storage media (e.g., on a CD, a DVD, a memory stick or other non-transitory medium). The computer program may be configured to run on a device or apparatus as an application. An application may be run by a device or apparatus via an operating system.

In another aspect, there is provided an apparatus, the apparatus comprising:
means for enabling determination of a location match between a location of an electronic device and a location of a contact, the contact associated with a contact entry for the electronic device, and
means for enabling the contact entry to be prioritised based on the location match.

The present disclosure includes one or more corresponding aspects, examples or features in isolation or in various combinations whether or not specifically stated (including claimed) in that combination or in isolation. Corresponding means and corresponding functional units (e.g., user location determiner, contact location determiner, location matcher, contact entry prioritiser) for performing one or more of the discussed functions are also within the present disclosure.

Corresponding computer programs for implementing one or more of the methods disclosed are also within the present disclosure and encompassed by one or more of the described examples.

### BRIEF DESCRIPTION OF THE FIGURES

A description is now given, by way of example only, with reference to the accompanying drawings, in which:

FIG. 1 illustrates an example apparatus according to the present disclosure;

FIG. 2 illustrates another example apparatus according to the present disclosure;

FIG. 3 illustrates a further example apparatus according to the present disclosure;

FIG. 4 illustrates location matching between an electronic device and a contact;

FIGS. 5a-5b illustrate prioritisation of location matched contacts on a portable electronic device;

FIGS. 6a-6b illustrate prioritisation of location matched categorised contacts on a non-portable electronic device;

FIGS. 7a-7b illustrate hierarchical prioritisation of location matched categorised contacts;

FIGS. 8a-8b illustrate an example apparatus in communication with a remote server/cloud;

FIG. 9 illustrates an example method according to the present disclosure; and

FIG. 10 illustrates schematically a computer readable medium providing a program.

### DESCRIPTION OF EXAMPLE ASPECTS

Other examples depicted in the figures have been provided with reference numerals that correspond to similar features of earlier described examples. For example, feature number 100 can also correspond to numbers 200, 300, 400, etc. These numbered features may appear in the figures but may not have been directly referred to within the description of these particular examples. These have still been provided in the figures to aid understanding of the further examples, particularly in relation to the features of similar earlier described examples.

Many modern electronic devices allow lists of contacts to be stored, accessed and edited. For example, a desktop computer may allow a user to use an electronic address book application. A contact person may have an entry in the electronic address book, and the entry may include information such as they contact's name, telephone numbers, e-mail addresses and physical postal addresses. Other examples of contact lists include a contact list of a mobile telephone or smartphone, which a user of the device may use to store contact telephone numbers and other contact information, and a social media contact list, which may include social media contact details for friends and followers in various social media networks.

Information in the contact lists may be edited by a user. For example, if a contact person moves house, the user may wish to update the stored contact information for that contact to include the contact's new address. A contact may change their location, for example if their physical address changes (as above), or a contact may transmit a new location via e-mail, SMS message, MMS message, a chat message, in a social media posting, or by transmitting (for example, via a Bluetooth or IR connection) a contact card including an updated location over a network from the contacts electronic device to a user's electronic device.

Contact information and other details of the user of the electronic device may also change. For example, the user may have a portable electronic device with GPS location determination functionality (such as a mobile telephone, smartphone or in-vehicle navigation device). The location of the user may therefore change depending on the movement of the user (and the user's portable electronic device). A user may also change his or her location, for example by manually updating the time/location on a portable electronic device if the user travels and changes international time zone.

A user may find it advantageous, if travelling to a new location, to easily identify which of his or her contacts are also in the same location (for example, to arrange meeting with them). A user may also find it advantageous to see which of his or her contacts are currently, or who may in the future move to be, in the same location as him/her. If the location of the user is determined to match the location of one or more contacts, then the contacts details (or a shortcut to the contact details) of these location matched contacts may be displayed on a home screen of an electronic device of the user, so that the user can quickly and easily identify contacts sharing the same location.

FIG. 1 shows an apparatus 100 comprising a processor 110, memory 120, input I and output O. In this example only one processor and one memory are shown but it will be appreciated that other examples may utilise more than one processor and/or more than one memory (e.g., same or different processor/memory types). The apparatus 100 may be an application specific integrated circuit (ASIC) for a portable electronic device. The apparatus 100 may also be a module for a device, or may be the device itself, wherein the processor 110 is a general purpose CPU and the memory 120 is general purpose memory.

The input I allows for receipt of signalling to the apparatus 100 from further components. The output O allows for onward provision of signalling from the apparatus 100 to further components. In this example the input I and output O are part of a connection bus that allows for connection of the apparatus 100 to further components. The processor 110 is a general purpose processor dedicated to executing/processing information received via the input I in accordance with instructions stored in the form of computer program code on the memory 120. The output signalling generated by such operations from the processor 110 is provided onwards to further components via the output O.

The memory 120 (not necessarily a single memory unit) is a computer readable medium (such as solid state memory, a hard drive, ROM, RAM, Flash or other memory) that stores computer program code. This computer program code stores instructions that are executable by the processor 110, when the program code is run on the processor 110. The internal connections between the memory 120 and the processor 110 can be understood to provide active coupling between the processor 110 and the memory 120 to allow the processor 110 to access the computer program code stored on the memory 120.

In this example the input I, output O, processor 110 and memory 120 are electrically connected internally to allow for communication between the respective components I, O, 110, 120, which in this example are located proximate to one another as an ASIC. In this way the components I, O, 110, 120 may be integrated in a single chip/circuit for installation in an electronic device. In other examples, one or more or all of the components may be located separately (for example, throughout a portable electronic device such as devices 200, 300, or within a network such as a “cloud” and/or may provide/support other functionality).

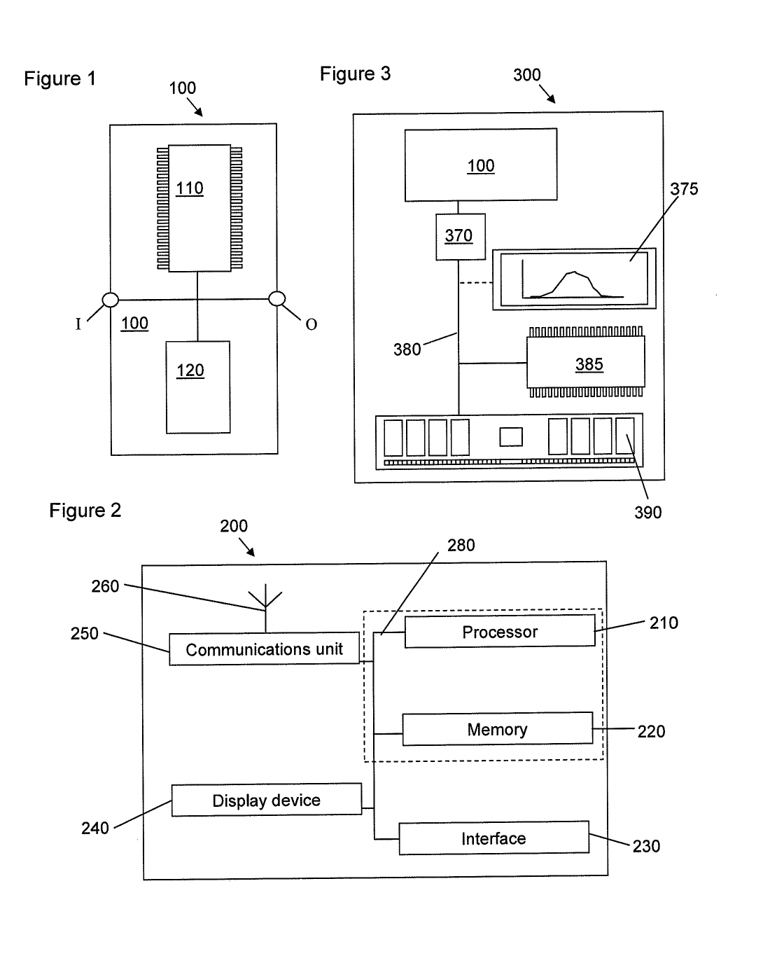

One or more examples of the apparatus 100 can be used as a component for another apparatus as in FIG. 2, which shows a variation of apparatus 100 incorporating the functionality of apparatus 100 over separate components. In other examples the device 200 may comprise apparatus 100 as a module (shown by the optional dashed line box) for a mobile phone or PDA or audio/video player or the like. Such a module, apparatus or device may just comprise a suitably configured memory and processor.

The example apparatus/device 200 comprises a display 240 such as, a Liquid Crystal Display (LCD), e-Ink, or touch-screen user interface (like a tablet computer). The device 200 is configured such that it may receive, include, and/or otherwise access data. For example, device 200 comprises a communications unit 250 (such as a receiver, transmitter, and/or transceiver), in communication with an antenna 260 for connection to a wireless network and/or a port (not shown). Device 200 comprises a memory 220 for storing data, which may be received via antenna 260 or user interface 230. The processor 210 may receive data from the user interface 230, from the memory 220, or from the communication unit 250. Data may be output to a user of device 200 via the display device 240, and/or any other output devices provided with apparatus. The processor 210 may also store the data for later user in the memory 220. The device contains components connected via communications bus 280.

The communications unit 250 can be, for example, a receiver, transmitter, and/or transceiver, that is in communication with an antenna 260 for connecting to a wireless network and/or a port (not shown) for accepting a physical connection to a network, such that data may be received via one or more types of network. The communications (or data) bus 280 may provide active coupling between the processor 210 and the memory (or storage medium) 220 to allow the processor 210 to access the computer program code stored on the memory 220.

The memory 220 comprises computer program code in the same way as the memory 120 of apparatus 100, but may also comprise other data. The processor 210 may receive data from the user interface 230, from the memory 220, or from the communication unit 250. Regardless of the origin of the data, these data may be outputted to a user of device 200 via the display device 240, and/or any other output devices provided with apparatus. The processor 210 may also store the data for later user in the memory 220.

The device/apparatus 300 shown in FIG. 3 may be an electronic device (including a tablet personal computer), a portable electronic device, a portable telecommunications device, or a module for such a device. The apparatus 100 can be provided as a module for device 300, or even as a processor/memory for the device 300 or a processor/memory for a module for such a device 300. The device 300 comprises a processor 385 and a storage medium 390, which are electrically connected by a data bus 380. This data bus 380 can provide an active coupling between the processor 385 and the storage medium 390 to allow the processor 385 to access the computer program code.

The apparatus 100 in FIG. 3 is electrically connected to an input/output interface 370 that receives the output from the apparatus 100 and transmits this to the device 300 via data bus 380. Interface 370 can be connected via the data bus 380 to a display 375 (touch-sensitive or otherwise) that provides information from the apparatus 100 to a user. Display 375 can be part of the device 300 or can be separate. The device 300 also comprises a processor 385 that is configured for general control of the apparatus 100 as well as the device 300 by providing signalling to, and receiving signalling from, other device components to manage their operation.

The storage medium 390 is configured to store computer code configured to perform, control or enable the operation of the apparatus 100. The storage medium 390 may be configured to store settings for the other device components. The processor 385 may access the storage medium 390 to retrieve the component settings in order to manage the operation of the other device components. The storage medium 390 may be a temporary storage medium such as a volatile random access memory. The storage medium 390 may also be a permanent storage medium such as a hard disk drive, a flash memory, or a non-volatile random access memory. The storage medium 390 could be composed of different combinations of the same or different memory types.

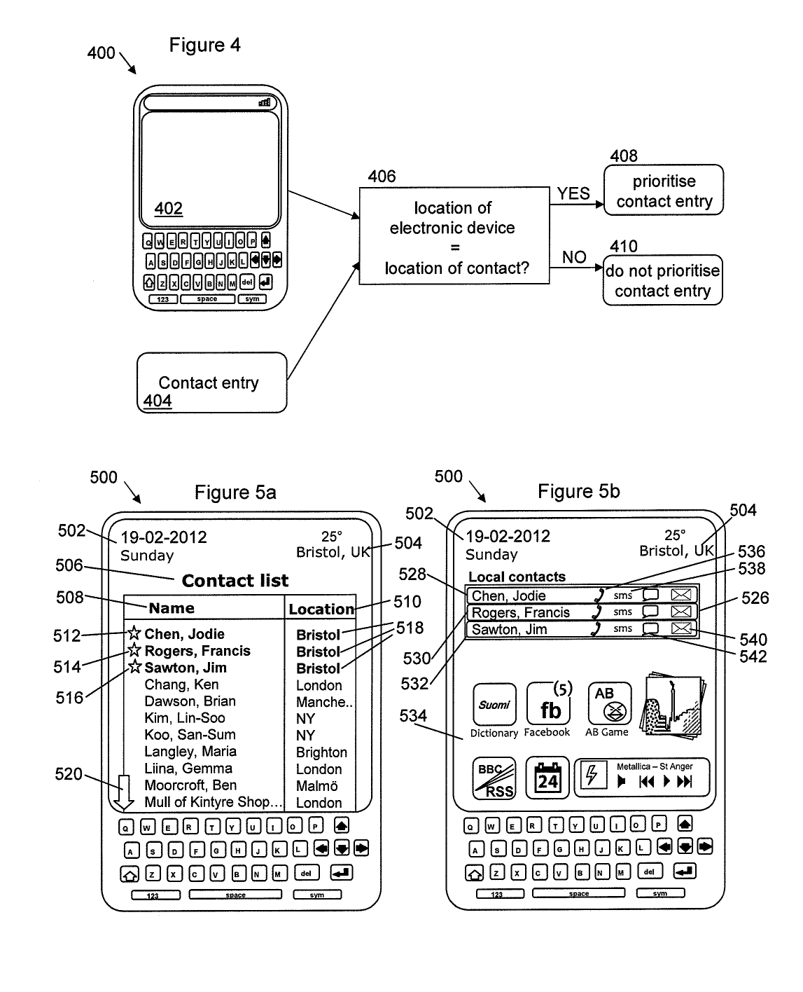

FIG. 4 illustrates location matching 400 between an apparatus/electronic device 402 and a contact entry 404. At step 406, the apparatus enables determination of a location match between a location of an electronic device 402 and a location of a contact 404. The contact is associated with a contact entry for the electronic device (for example, the contact person may be listed in an address book of the electronic device 402 as a contact entry). The apparatus enables the contact entry 404 to be prioritised based on the location match. If the location of the electronic device 402 and the contact entry 404 match, then their locations are determined to match and the contact entry is prioritised 408. If the location of the electronic device 402 and the contact entry 404 do not match (i.e. are different within the specifications of the location matching criteria), then their locations are determined not to match, and the contact entry is not prioritised 410.

FIGS. 5a-5b illustrate an apparatus/portable electronic device 500 such as a mobile telephone, smartphone, PDA, desktop or tablet computer in operation. The apparatus/portable electronic device 500 is displaying the current date and day 502, and the current location and weather conditions 504 of the apparatus/portable electronic device 500. The apparatus/portable electronic device 500 may determine the current location using GPS (or cellular triangulation), for example.

In FIG. 5a, the apparatus/portable electronic device 500 is also displaying a contact list 506 including the name 508 and location 510 of a plurality of contacts. In other examples the location 510 need not necessarily be displayed as shown (or even stored on the device 500). The contact list cannot be displayed in one screen in this example and the user may scroll through the list using a scroll arrow 520, or other scrolling means (such as dragging a finger down a touch sensitive screen of the apparatus/device 500), to see other entries in the contact list 506. Of course, other information about the contacts may be displayed in such a list, or may be displayed, for example, by a user selecting a contact entry from the contact list. Other contact entry information which may be included in such a contact entry include a contact photo, contact fixed/landline telephone number, contact mobile telephone number, contact work postal address, contact home postal address, contact work email address, contact home e-mail address, contact social medium address, or a shortcut for one or more of the same.

The location of the contact may be determined, for example, from the listed contact fixed/landline telephone number (e.g., from the country and/or dialing code), or from the contact work or home postal address (or both, giving the user a personal postal address location and a work postal address location, if the two locations are different). In other examples, the location may be provided to the contact entry in the list manually by the user, or may be detected from a message transmitted to the portable electronic device. Such a message may be an e-mail, SMS, MMS, chat message, social media message or blog message received by the portable electronic device user from the contact.

In this example, three contacts 512, 514, 516 have been determined to have a location (Bristol 518) which matches the location of the user's portable electronic device 500 (Bristol 504). These contact entries have been prioritised as they have locations matching that of the user's portable electronic device. In this illustrative example, the prioritisation comprises displaying the prioritised contact entries 512, 514, 516 at the top of the contact list 506, in bold type, and with a favorite “star” icon 522 next to the contact entries. Of course, any combination of these prioritisation schemes may be used, and others (e.g., display in a different colour, display with a (coloured) border/underlining) may be envisaged which are known to those skilled in the art.

Therefore, FIG. 5a illustrates an apparatus/device 500 configured to enable a contact entry 512, 514, 516 to be prioritised by reordering a list of contact entries 506 associated with respective contacts in a hierarchical order. In this case the hierarchy has prioritised contacts 512, 514, 516 by listing them at the top of the list and includes other non-prioritised contacts lower in the list of contact entries 506. The contact entries 512, 514, 516 associated with the location match are placed higher in the hierarchical list of contact entries 506.

FIG. 5b illustrates a home screen 524 of the apparatus/portable electronic device 500, again displaying the current date and day 502, and the current location and weather conditions 504 of the apparatus/portable electronic device 500. In this example, contact entries which have been determined to have a location matching the location of the apparatus/portable electronic device 500 are displayed 526, or pinned, to the home screen 524. Access to these contact entries, in this embodiment, was not previously available on the home screen in this way. Therefore, the apparatus is configured to enable a contact entry 528, 530, 532 to be prioritised by pinning the contact entry, or by pinning a shortcut associated with the contact entry, to a home screen 524 of the apparatus/device 500 according to the location match (in this case, Bristol).

The apparatus/device 500 may pin contact entries to the home screen for the duration of the location match, and if the location of either the apparatus/portable electronic device 500 or one or more of the pinned contacts 528, 530, 532 changes such that there is no longer a location match, the non-location matched contact(s) may be removed/unpinned from the home screen 524 and/or de-prioritised in the contact list 506. The apparatus/device 500 may detect a change in the location of the apparatus/portable electronic device 500 and/or of the pinned contact entries 528, 530, 532, and un-pin any contact which no longer has a location matching that of the apparatus/portable electronic device 500.

This pinning to the home screen prioritises those location matched contacts 528, 530, 532, since the user need only look at the home screen of the portable electronic device 500 in order to see which contacts are in the same location/area. The user is not required to provide any input in order to reach a screen listing the locations of contact entries, nor is the user required to scroll through a contact entry list and look at the locations of each contact to determine which contacts are in the same area/location. The user can still access other functionality of the portable electronic device 500 from the home screen as illustrated by the icons 534 representing other available applications (such as a dictionary application, a social media application, a game, a photograph album, an RSS news feed link, a calendar application, and a music playing application).

In FIG. 5b, the contact entries 528, 530, 532 pinned to the home screen 524 are actuable, and allow for electronic communication with the corresponding contact. For example, the user of the apparatus/portable electronic device 500 may be able to readily select (e.g., by touching) the telephone icon 536 of a particular contact entry 528, 530, 532 to call that contact. The user may be able to readily select the “sms” icon 538 of a particular contact entry 528, 530, 532 to open an SMS messaging application and compose and transmit an SMS message to the corresponding contact. The user may be able to readily select the chat icon 540 of a particular contact entry 528, 530, 532 to open a chat application and compose and transmit an chat message to the corresponding contact. The user may be able to readily select the e-mail icon 542 of a particular contact entry 528, 530, 532 to open an e-mail application and compose and transmit an e-mail message to the corresponding contact. Upon selecting the e-mail icon 452 of a contact 528, 530, 532, the e-mail application may open with the “To:” field already completed with the e-mail address of the relevant contact (from whose contact entry 528, 530, 532 the e-mail icon 542 was selected).

In other examples, the contact entries which are prioritised or pinned to the home screen 524, may not be actuable and may serve to just show to the user of the apparatus/portable electronic device 500 which contacts are in the same location.

In FIGS. 5a-5b, the apparatus/electronic device 500 is a portable electronic device 500 such that its location can vary (as indicated in the top right of the screen 504).

The location of a contact such as those listed in the contact list 506 may be fixed (e.g., the contact may have a fixed location of, for example, a business premises). The apparatus/device 500 may be configured, in this example, to enable the determination of the location match between the varying location of the portable electronic device and the fixed location of the contact. For example, the apparatus/device 500 may check to determine if there are any, and if so which, contact entries have a matching location with the portable electronic device 500, upon a change in the location of the apparatus/portable electronic device 500 being detected (for example, if the user of the apparatus/portable electronic device 500 is travelling by train and the apparatus/device 500 is able to determine its location using GPS or by cellular triangulation).

The location of the contact may be such that the location of the contact can also vary. A contact may be able to update their changing location. For example, a contact may be on a travelling holiday through South America and may update their location on a social media website using their mobile telephone or by logging into their social media account(s) at internet cafés. The apparatus/device 500 may, in this example, be configured to enable the determination of the location match between the varying location of the apparatus/portable electronic device 500 and the varying location of the contact. The apparatus/device 500 may be able to check and determine if there are any location matches between the apparatus/portable electronic device 500 and any contacts listed in the contact list 506, upon detecting that either the location of the apparatus/portable electronic device 500 or the location of one or more of the contacts has changed.

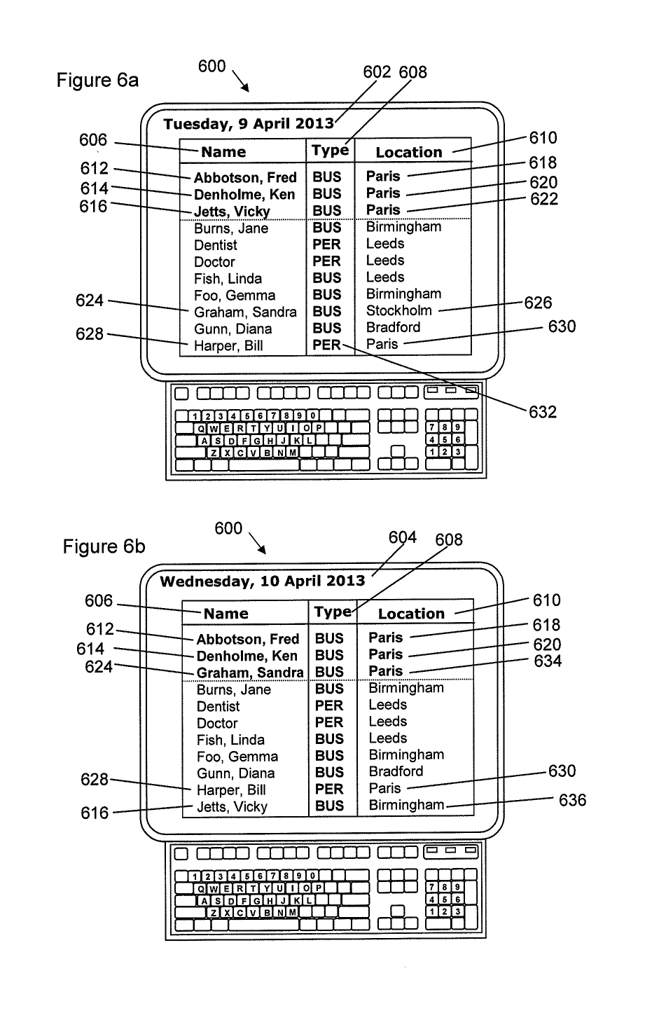

FIG. 6 illustrates an apparatus/electronic device 600 such as a laptop or desktop computer. FIG. 6a shows a current contact list on Tuesday 9 Apr. 2013 602. FIG. 6b shows a future contact list, that is, how the contact list will appear at a time in the future (in this example, on Wednesday 10 Apr. 2013 604).

The apparatus/device 600 shows a contact list displaying contact entry names 606, a contact type 608, and contact location 610. The contact type 608 indicates what category of contact each contact belongs to. For example, family and friends may be categorised as personal (PER) contacts, whereas business contacts and colleagues may be categorised as business (BUS) contacts. Other possible contact entry categorisation may be envisaged, such as grouping contacts by family (e.g., family members only), friends (e.g., friends who are not family members), holiday contacts (e.g., people who the user has met or is due to meet on holiday), business trip contacts (e.g., people who may be colleagues, or who may work at other businesses, who the user may wish to contact concerning business travel), and social media contacts (such as contacts from social media websites or blog sites who the user may often correspond with through internet-based media, rather than face to face).

The current location in this example of the user is fixed, and is Paris (not shown). The user is planning business meetings at his office in Paris using a calendar function and his contact list on his electronic device 600. In FIG. 6a, the contact list shows three business (BUS) contact entries 612, 614, 616 associated with contacts who are currently located in Paris 618, 620, 622.

Another contact entry 628 is also showing a contact located in Paris 630, but relates to a personal (PER) contact 632 and not to a business (BUS) contact. In this example, the apparatus/device 600 is configured to enable the determination of a location match for contact entries having a particular categorisation, in this example, those contacts categorised as business (BUS) contacts. Therefore, personal and other non-business contacts are not location matched with the user and so contact entry 628 is not location matched, and therefore not prioritised.

In other examples, the apparatus/device 600 may be configured to perform location matching for all contacts regardless of any categorisation, but be configured to enable a contact entry to be prioritised only if that contact entry has a particular categorisation. In this case, the contact associated with contact entry 628 may be location matched, but would not be prioritised.

In FIG. 6b, the user is planning for a future business meeting (on the next day, the 10 Apr. 2013 604). The user's calendar (not shown) indicates that business (BUS) contact Sandra Graham listed as a contact entry 624 will be in Paris 634 on that day. Since the contact associated with contact entry 624 is categorised as a business contact (included in location matching in this example), contact entry 624 is included in location matching by the apparatus. Since the contact associated with business contact entry 624 has a location matching that of the user on Wednesday 10 Apr. 2013, contact entry 624 is prioritised at the top of the contact list and shown in bold type on this date when the locations of the contact and the user's electronic device match.

Note that the contact having a contact entry 624 was not in Paris (the location of the user), on Tuesday 9 Apr. 2013, but was in Stockholm 626. Therefore there was no location match between the user and this contact on Tuesday 9 Apr. 2013, thus contact entry 626 was not prioritised in FIG. 6a.

The user's calendar also indicates in FIG. 6b that business (BUS) contact Vicky Jetts, listed as a contact entry 616, will have left Paris and be in Birmingham 636 on Wednesday 10 Apr. 2013. The contact associated with contact entry 616 is categorised as a business contact and is therefore included in location matching in this example. However, since the contact associated with business contact entry 616 has a location 636 which does not match that of the user on Wednesday 10 Apr. 2013, contact entry 616 is not prioritised and appears with other non-prioritised contact entries in the contact list in FIG. 6b for Wednesday 12 Apr. 2013.

FIGS. 6a-6b may be considered to show, in the case where device 600 is non-portable (e.g., a desktop computer), that an apparatus/electronic device 600 has a fixed location, and the location of the contacts may be such that the location of the contacts can vary. The apparatus/device 600 may be configured to enable the determination of a location match between the fixed location of the apparatus/non-portable electronic device 600 and the varying location of the contacts.

FIGS. 6a-6b illustrate that the location of the contact used in the location match may be the current location of the contact (as in FIG. 6a) and/or a future location of the contact (as in FIG. 6b). The respective current and future locations of the contacts determined from location data may be provided by apparatus/device 600 associated with the contacts of the contact entries (for example, from the user's electronic device receiving an e-mail or other electronic message providing the location of the contact at a particular time). In this example, the future location of a contact is determined from a calendar event associated with the user's apparatus/electronic device 600. The calendar event may have been received from a calendar invitation message transmitted by a contact and received/entered by/using the user's electronic apparatus/device 600.

In other examples, in which the user's apparatus/electronic device 600 is a portable electronic device such as laptop computer, the location of the apparatus/electronic device 600 used in the location match may be one or more of the current location of the apparatus/electronic device 600 or a future location of the apparatus/electronic device 600. The future location of the apparatus/electronic device 600 may be determined from a calendar event associated with the apparatus/electronic device 600. For example, the user's location may change from Tuesday 9 Apr. 2013 to Wednesday 10 Apr. 2013 (for example by the user travelling to a different location for a meeting), and this may cause the apparatus/device 600 to determine a future location match using the user's planned new location.

As a further example concerning location matching contact entries with a particular characterisation, a user may be away on a business trip for three months, and location-matched business and personal contacts may be prioritised and/or pinned to a home screen of an electronic device. If the user specifies a calendar entry for vacation time/personal holiday during these three months, then since the user may not wish to contact business contacts during the vacation time, any prioritised contacts categorised as business contacts may be de-prioritised and/or removed from being pinned to a home screen during the vacation time. Prioritised contacts categorised as personal contacts may remain prioritised and/or pinned to the home screen during the vacation time. After the vacation time is over, these de-prioritised and/or un-pinned business colleague contact entries may be re-prioritised and/or re-pinned to the home screen. In this way, the apparatus is able to detect the information included in calendar entries regarding business and personal events, for example, to prioritise business and personal contact entries appropriately depending on the scheduled activities of the user.

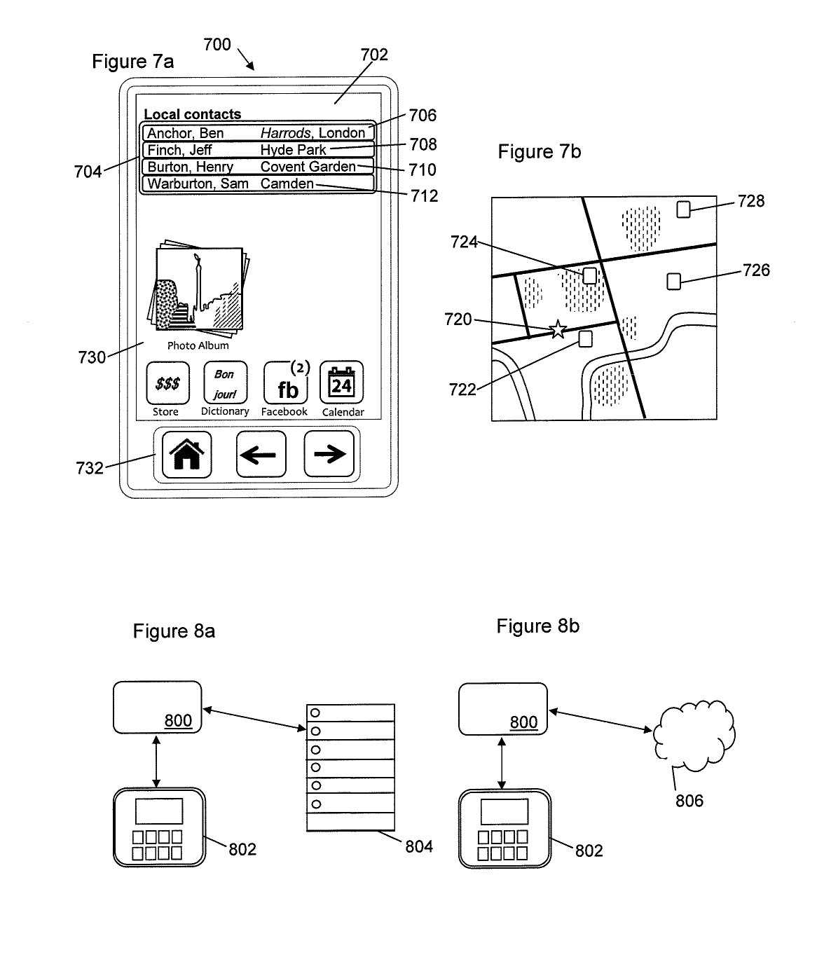

FIGS. 7a-7b show a portable electronic device 700 displaying a home screen 702. The electronic device home screen shows a list of four pinned contact entries 704 as well as icons 730 illustrating other functionality of the device 700 (such as access to an internet based marketplace, a French dictionary application, a social media application, and a calendar application. Also illustrated are illustrative general controls 732 such as a home screen button, and forward and backward controls).

Four contact entries are shown 704 to be location matched with the location of the user's electronic device 700 and are prioritised by being pinned to the home screen in a “pinned contact” area 704 labelled “local contacts”. The user (and the user's portable electronic device 700) are currently on Brompton Road, near Harrods department store in London. This is shown as the star 720 on the map of FIG. 7b. The local contacts list 704 shows that one contact is in the Harrods department store in London 706, another contact is in Hyde Park 708, a further contact is in Covent Garden 710, and a fourth contact is in Camden 712. These four contacts are the only contacts with contact entries having a current location in the London area. Other non-pinned/prioritised contacts have current locations outside London (for example, in other UK towns or in countries outside the UK).

FIG. 7b shows a schematic map of the area of London which includes the location of the user 720, Harrods department store 722, Hyde Park 724, Covent Garden 726, and Camden 728. From this map it can be seen that the contact in Harrods 722 is closest to the user's current location 720, and therefore the corresponding contact entry 704 for this contact is prioritised at the top of the pinned list of prioritised contacts 704 on the home screen 702. The next closest contact to the location of the user 720 is located in Hyde Park 722, so his corresponding contact entry is next in the pinned contact entry list 704. Next closest to the contact's location 720 is the contact in Covent Garden 726, so his contact entry is next in the pinned contact entry list 704. Next closest to the contact's location 720 is the contact in Camden 728, so his contact entry is next in the list 704, and last in the pinned contact entry list 704. There are no other contacts with locations within the London area.

In this example, the London area has been provided as the predetermined location proximity within which the apparatus/device 700 is configured to enable the determination of a location match, based on the location of the electronic device 700 (and the user of the device 700) and the location of a contact.

In other examples, the predetermined location proximity may be given as a particular distance from the location of the user, or within the same county/state/region/country of the user. The user may be able to change the setting of the apparatus/device 700 to specify what predetermined location proximity criterion the apparatus/device 700 can use to determine contact location matches.

FIG. 7a also illustrates that the apparatus/device 700 is configured to order multiple contact entries 706, 708, 710, 712 associated with contacts who have a location match with the user (i.e. are location within London) according to location proximity. Those contacts with locations closer to the location of the user (and the user's electronic device 700) are placed higher in the list). That is, the contact entry 706 associated with the closest location proximity 722 is placed with a higher priority in the hierarchical list of contact entries 704 than contacts 708, 710, 712 who are further away from the user.

The abovementioned examples discuss prioritisation by displaying a location-matched contact entry in a prioritised way. It may be envisaged in other examples that the prioritisation of a contact entry may be achieved by a sound alert associated with the contact entry and indicating that the contact entry is location-matched. It may also be envisaged that, for example, if a location-matched contact entry is prioritised by being displayed in some prioritised way, then this display may be accompanied by an associated sound alert and/or vibration/haptic feedback to indicate that a contact has been location-matched (or in other examples, that a previously location-matched contact entry is no longer location-matched and is therefore de-prioritised).

FIG. 8a shows an example embodiment of an apparatus in communication with a remote server. FIG. 8b shows that an example embodiment of an apparatus in communication with a “cloud” for cloud computing. In FIGS. 8a and 8b, apparatus 800 (which may be apparatus 100, 200 or 300) is in communication with a display 802 which may display a home screen. Of course, the apparatus 800 and display 802 may form part of the same apparatus/device, although they may be separate as shown in the figures. The apparatus 800 is also in communication with a remote computing element. Such communication may be via a communications unit, for example. FIG. 8a shows the remote computing element to be a remote server 804, with which the apparatus may be in wired or wireless communication (e.g., via the internet, Bluetooth, a USB connection, or any other suitable connection as known to one skilled in the art). In FIG. 8b, the apparatus 800 is in communication with a remote cloud 806 (which may, for example, by the Internet, or a system of remote computers configured for cloud computing). It may be that the contact entries and/or at least some user applications are stored/run at the remote computing element 804, 806 and accessed by the apparatus 800 for display 802. User applications and contact entries need not all be stored at the same location. Some or all of the user applications and/or contact entries may be stored at the apparatus 100, 200, 300, 800, and/or at the remote computing element 804, 806. The apparatus 800 may actually form part of the remote sever 804 or remote cloud 806. In such embodiments, the enablement of the determination of a location match between a location of an electronic device and a location of a contact, the contact associated with a contact entry for the electronic device, and the enablement of the contact entry to be prioritised based on the location match may be conducted by the server/cloud 804, 806 or in conjunction with use of the server/cloud 804, 806 for prioritisation (e.g., which can be viewed by display, or output via a sound alert/speaker and/or via haptic feedback/vibration) at the apparatus 800, 802.

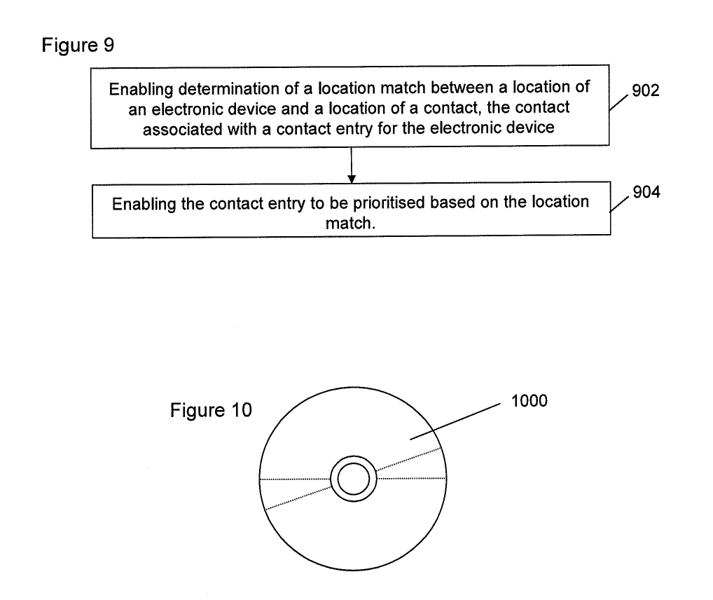

FIG. 9 shows a flow diagram illustrating a method of enabling determination of a location match between a location of an electronic device and a location of a contact, the contact associated with a contact entry for the electronic device 902, and enabling the contact entry to be prioritised based on the location match 904, and is self-explanatory.

FIG. 10 illustrates schematically an example comprising a computer/processor readable medium 1000 providing a computer program. In this example, the computer/processor readable media is a disc such as a digital versatile disc (DVD) or a compact disc (CD). In other examples, the computer readable media may be any media that has been programmed in such a way as to carry out an inventive function.

It will be appreciated to the skilled reader that any mentioned apparatus/device and/or other features of particular mentioned apparatus/device may be provided by apparatus arranged such that they become configured to carry out the desired operations only when enabled, e.g., switched on, or the like. In such cases, they may not necessarily have the appropriate software loaded into the active memory in the non-enabled (e.g., switched off state) and only load the appropriate software in the enabled (e.g., on state). The apparatus may comprise hardware circuitry and/or firmware. The apparatus may comprise software loaded onto memory. Such software/computer programs may be recorded on the same memory/processor/functional units and/or on one or more memories/processors/functional units.

In some examples, a particular mentioned apparatus/device may be pre-programmed with the appropriate software to carry out desired operations, and wherein the appropriate software can be enabled for use by a user downloading a “key”, for example, to unlock/enable the software and its associated functionality. Advantages associated with such examples can include a reduced requirement to download data when further functionality is required for a device, and this can be useful in examples where a device is perceived to have sufficient capacity to store such pre-programmed software for functionality that may not be enabled by a user.

It will be appreciated that the any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g., memory, signal).

It will be appreciated that any “computer” described herein can comprise a collection of one or more individual processors/processing elements that may or may not be located on the same circuit board, or the same region/position of a circuit board or even the same device. In some examples one or more of any mentioned processors may be distributed over a plurality of devices. The same or different processor/processing elements may perform one or more functions described herein.

With reference to any discussion of any mentioned computer and/or processor and memory (e.g., including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects may consist of any such individual feature or combination of features. In view of the foregoing description it will be evident to a person skilled in the art that various modifications may be made within the scope of the disclosure.

While there have been shown and described and pointed out fundamental novel features of the disclosure as applied to examples thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or example may be incorporated in any other disclosed or described or suggested form or example as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
enable determination of a location match between a location of an electronic device and a location of a contact, the contact associated with a contact entry for the electronic device, and
enable the contact entry to be prioritized based on the location match, wherein the apparatus is configured such that one or more of:
multiple contact entries associated with the location match are ordered according to location proximity, the contact entries associated with the closest location proximity being placed with a higher priority in the hierarchical list of contact entries;
the determination of the location match for contact entries having a particular pre-stored contact type categorization is enabled;
the prioritization of the contact entry is enabled based on the location match by pinning the contact entry, or by pinning a shortcut associated with the contact entry, to a home screen of the electronic device according to the location match;
the prioritization of the contact entry is enabled for contact entries having a particular pre-stored contact type categorization;
the location of the electronic device used in the location match is the future location of the electronic device determined from a calendar event associated with the electronic device; or
the location of the contact used in the location match is the future location of the contact determined from location data provided by an apparatus associated with the contact of the contact entry.

2. (canceled)

3. An apparatus according to claim 1, wherein the location of the contact used in the location match is the current location of the contact determined from location data provided by an apparatus associated with the contact of the contact entry.

4. An apparatus according to claim 1, wherein the electronic device is a portable electronic device such that its location can vary, and the location of the contact is fixed, and wherein the apparatus is configured to:
enable the determination of the location match between the varying location of the portable electronic device and the fixed location of the contact.

5. An apparatus according to claim 1, wherein the electronic device is a non-portable electronic device such that its location is fixed, and the location of the contact is such that the location of the contact can vary, and wherein the apparatus is configured to:
enable the determination of the location match between the fixed location of the non-portable electronic device and the varying location of the contact.

6. An apparatus according to claim 1, wherein the electronic device a portable electronic device such that its location can vary, and the location of the contact is such that the location of the contact can vary, and wherein the apparatus is configured to:
enable the determination of the location match between the varying location of the portable electronic device and the varying location of the contact.

7. (canceled)

8. An apparatus according to claim 1, wherein the apparatus is configured to enable the contact entry to be prioritized by pinning the contact entry, or by pinning a shortcut associated with the contact entry, to a home screen of the electronic device according to the location match for the duration of the location match.

9. An apparatus according to claim 1, wherein the apparatus is configured to enable the contact entry to be prioritized by reordering a list of contact entries associated with respective contacts in a hierarchical order, the contact entry associated with the location match being placed higher in the hierarchical list of contact entries.

10. (canceled)

11. An apparatus according to claim 1, wherein the apparatus is configured to enable the determination of the location match based on the location of the electronic device and the location of the contact being within a predetermined location proximity.

12. (canceled)

13. (canceled)

14. An apparatus according to claim 1, wherein, when the apparatus is configured to enable the contact entry to be prioritized for contact entries having a particular pre-stored contact type categorization, the apparatus is configured such that the contact entry pre-stored contact type categorization provides for grouping of contact entries, the grouping including one or more of business contact grouping, family contact grouping, friend contact grouping, holiday contact grouping, and business trip contact grouping.

15. An apparatus according to claim 1, wherein the apparatus is configured to receive the location of the contact from one or more of an application associated with the contact or an apparatus associated with the contact.

16. An apparatus according to claim 1, wherein the contact entry is configured to store contact details for the contact, the contact details comprising one or more of a contact name, contact photo, contact fixed/landline telephone number, contact mobile telephone number, contact work postal address, contact home postal address, contact work email address, contact home e-mail address, contact social medium address, or a shortcut for one or more of the same.

17. A method comprising:
enabling determination of a location match between a location of an electronic device and a location of a contact, the contact associated with a contact entry for the electronic device, and
enabling the contact entry to be prioritized based on the location match, wherein the method further comprises one or more of:
ordering multiple contact entries associated with the location match according to location proximity is performed, the contact entries associated with the closest location proximity being placed with a higher priority in the hierarchical list of contact entries:
enabling the determination of the location match for contact entries having a particular pre-stored contact type categorization;
enabling the contact entry to be prioritized based on the location match by pinning the contact entry, or by pinning a shortcut associated with the contact entry, to a home screen of the electronic device according to the location match;
enabling the contact entry to be prioritized for contact entries having a particular pre-stored contact type categorization;
the location of the electronic device used in the location match being the future location of the electronic device determined from a calendar event associated with the electronic device; or
the location of the contact used in the location match being the future location of the contact determined from location data provided by an apparatus associated with the contact of the contact entry.

18. A computer readable medium comprising computer program code stored thereon, the computer readable medium and computer program code being configured to, when run on at least one processor, perform at least the following:
enable determination of a location match between a location of an electronic device and a location of a contact, the contact associated with a contact entry for the electronic device, and enable the contact entry to be prioritized based on the location match, further comprising computer code configured such that one or more of:
multiple contact entries associated with the location match are ordered according to location proximity, the contact entries associated with the closest location proximity being placed with a higher priority in the hierarchical list of contact entries;
the prioritization determination of the location match for contact entries having a particular pre-stored contact type categorization is enabled;
the prioritization of the contact entry is enabled based on the location match by pinning the contact entry, or by pinning a shortcut associated with the contact entry, to a home screen of the electronic device according to the location match;
the prioritization of the contact entry is enabled for contact entries having a particular pre-stored contact type categorization;
the location of the electronic device used in the location match is the future location of the electronic device determined from a calendar event associated with the electronic device; or
the location of the contact used in the location match is the future location of the contact determined from location data provided by an apparatus associated with the contact of the contact entry.
